(19) United States
(12) Patent Application Publication
(10) Pub. No.: US 2026/0319241 A1
(43) Pub. Date: Oct. 15, 2026

(54) LIQUID MIRROR

(71) Applicant: Honeywell International Inc., Charlotte, NC (US)

(72) Inventors: Stephen Yates, South Barrington, IL (US); Rebecca Kamire, Buffalo Grove, IL (US); Emir Rahislic, Chicago, IL (US)

(21) Appl. No.: 19/177,297

(22) Filed: Apr. 11, 2025

(51) Int. Cl. G02B 26/08; G02B 7/183; G02B 7/185; G02B 23/06

(52) U.S. Cl. CPC G02B 26/0816; G02B 7/183; G02B 7/185; G02B 23/06

(57) ABSTRACT

An example liquid mirror includes a first liquid and a second liquid, the first liquid and the second liquid are immiscible with each other, and the second liquid comprises an ionic ferrofluid. The liquid mirror also includes a plurality of reflective particles configured to self-assemble at an interface between the first liquid and the second liquid, and a mirror base configured to house the first liquid and the second liquid, the mirror base comprising a surface configured to wet the second liquid across the surface.

### GOVERNMENT RIGHTS

This invention was made with Government support under FA237724CB011 awarded by DCMA. The Government has certain rights in the invention.

### TECHNICAL FIELD

The present disclosure relates to mirrors and techniques for making and using mirrors.

### BACKGROUND

Mirrors for telescopes are typically made using solid materials which can be polished such as glass, metal, or ceramic and coated with reflective thin films. This approach becomes increasingly expensive with increasing mirror diameter, and increasingly susceptible to damage (e.g., by contact with debris) with increasing mirror diameter.

### SUMMARY

In general, the disclosure describes a liquid mirror and methods of making and/or using liquid mirrors. A liquid mirror for use in telescopes or other applications may be made by supporting reflective particles at the interface of a bilayer of two immiscible liquids in a suitably shaped surface of a mirror base (or support structure), e.g., a dish. The lower liquid, e.g., the liquid adjacent to the shaped surface of the mirror base, may be a liquid held against the shaped surface by force, e.g., an acceleration such as gravity, or the lower liquid may be a ferrofluid configured to be held against the shaped surface by a magnetic force from an array of magnets placed on or within the mirror base. At the interface between the lower and upper liquids reflective particles may be configured to self-assemble into a relatively thin layer, e.g., a monolayer, having a relatively high reflectance. In examples in which the lower liquid is a ferrofluid, the lower liquid may comprise a suspension of magnetic particles in an ionic liquid, the magnetic particles being functionalized with a promoter and/or modifier configured to keep the particles in suspension, e.g., by preventing agglomeration of the magnetic particles. The array of magnets may be configured to shape the surface of the lower ferrofluid, e.g., as a focusing shape having an optical quality smoothness, however, the magnetic field and/or magnetic force from the array of magnets may have a periodic pattern which may result in variation in fluid height of the lower ferrofluid, e.g., resulting in surface shape variations.

In accordance with one or more aspects of this disclosure, surface characteristics of the mirror base may be tuned to form a relatively thin lower ferrofluid and reduce and/or eliminate variation in fluid height of the lower ferrofluid and/or reduce dewetted areas (e.g., from a mirror base surface) and gaps and/or pinholes in the surface area coverage of the lower ferrofluid. For example, a liquid mirror may include a mirror base configured to house a first liquid (e.g., the upper liquid) and a second liquid (e.g., the lower liquid) and the mirror base may comprise a surface configured to wet the second liquid across the surface of the mirror base. In some examples, the mirror base may comprise a coating configured to wet the second liquid, e.g., an oxide coating. In other examples, the surface of the mirror base may be anodized, e.g., forming an aluminum oxide or titanium oxide surface. In some examples, the coating and/or anodization of the surface may comprise a microstructure having a surface roughness greater than or equal to 500 micrometers, or greater than or equal to 100 micrometers, or greater than or equal to 50 micrometers, or greater than or equal to 10 micrometer, or greater than or equal to 1 micrometer, or greater than or equal to 0.5 micrometers.

Aspects of this disclosure may provide one or more technical advantages and solve one or more technical problems. For example, a mirror base configured to wet the second, lower ferrofluid enables a relatively thin ferrofluid, which enables control of the surface shape and surface roughness of the lower ferrofluid by a magnet array housed in the mirror base and/or a support structure of the liquid mirror. The magnetic field of magnets reduces as a function of distance from the magnets, and a relatively thin lower ferrofluid reduces variation of the magnetic field as a function of the liquid height (e.g., fluid thickness) of the lower ferrofluid and enables design of an array of magnets to reduce and/or eliminate surface height variations of the lower ferrofluid. A liquid mirror comprising a mirror base surface configured to wet the second liquid may provide a second liquid with reduced or nonvarying surface height such that the plurality of reflective particles at the interface between the first liquid and the second liquid may self-assemble to form a reflective layer having the focusing shape and having a surface flatness wavefront error of less than or equal to λ/2.

As one example, a liquid mirror includes: a first liquid and a second liquid, wherein the first liquid and the second liquid are immiscible with each other, wherein the second liquid comprises an ionic ferrofluid; a plurality of reflective particles configured to self-assemble at an interface between the first liquid and the second liquid; and a mirror base configured to house the first liquid and the second liquid, the mirror base comprising a surface configured to wet the second liquid across the surface.

As another example, a telescope includes: a focal plane configured to capture an image of a scene; a liquid mirror comprising: a first liquid and a second liquid, wherein the first liquid and the second liquid are immiscible with each other, wherein the second liquid comprises an ionic ferrofluid; a plurality of reflective particles configured to self-assemble at an interface between the first liquid and the second liquid; and a mirror base configured to house the first liquid and the second liquid, the mirror base comprising a surface configured to wet the second liquid across the surface; and a support structure configured to position the liquid mirror to image light to the focal plane, wherein the support structure is configured to tilt and slew the liquid mirror and focal plane together.

As another example, a method of forming a liquid mirror includes: treating a surface of a mirror base with at least one of an oxide or an anodization; disposing a first liquid, a second liquid, and a plurality of reflective particles onto the surface, wherein the first liquid and the second liquid are immiscible with each other, wherein the second liquid comprises an ionic ferrofluid, wherein the plurality of reflective particles are configured to self-assemble at an interface between the first and second liquids; and forming a focusing shape of a liquid mirror by applying a magnetic force to the second liquid such that the reflective particles self-assemble into the focusing shape at the interface.

The details of one or more examples are set forth in the accompanying drawings and the description below. Other features, objects, and advantages will be apparent from the description and drawings, and from the claims.

### BRIEF DESCRIPTION OF THE FIGURES

FIG. 1 is a schematic cross-sectional view of an example optical system including a liquid mirror.

FIG. 2 is a schematic cross-sectional view of an example a liquid mirror.

FIG. 3A is a schematic cross-sectional view of an example contact angle between a mirror base surface and a second liquid of the liquid mirror of FIG. 2.

FIG. 3B is an image of an example liquid mirror housed a mirror base including a surface having a relatively high contact angle with a second liquid.

FIG. 3C is an image of another example liquid mirror housed a mirror base including a surface having a relatively low contact angle with a second liquid.

FIG. 4 is a flow diagram illustrating an example technique of making a liquid mirror.

### DETAILED DESCRIPTION

A reflector for an optical telescope may typically include a solid
piece of material, such as glass, quartz, ceramic, or metal, which may be machined to extremely tight tolerances, polished to extreme smoothness, and covered with special reflective and/or durability enhancing coatings. Special machinery exists within the
optics industry to achieve the necessary precision and accuracy for small-to-medium sized reflectors at a reasonable cost, however, for large (e.g., greater than or equal to 0.5 meter (m) diameter) reflectors, the cost and time required to produce a reflector of sufficient quality may be exponentially higher, if not altogether prohibitive. Additionally, periodic maintenance and refurbishing of the reflective surface may be required during the service life of the reflector, which may also be costly and time consuming.

Use of a liquid mirror (LM) for a telescope may be significantly less expensive, more robust, and more rapidly deployed. The cost of making a liquid mirror may increase substantially linearly with increasing mirror diameter. Liquid mirrors may be able to “heal” after contact with debris or after other disturbances of the liquid surface or reflecting surface (e.g., interface) from other forces, e.g., wind, vibration, or the like.

In some examples, a liquid mirror may be formed by supporting reflective particles at the interface of a bilayer of two immiscible liquids in a suitably shaped surface of a mirror base, as stated above. The first liquid may be an upper liquid (e.g., away from the mirror base), and the second liquid may be a lower liquid. The lower liquid may be a ferrofluid that is held against a shaped front, or outer, surface of the mirror base by an array of magnets positioned on or in the mirror base. The lower ferrofluid may include a plurality of magnetic particles, e.g., maghemite, magnetite, or the like, functionalized with a promoter/modifier that keeps the particles in suspension, preventing agglomeration. The reflective particles may comprise a metal such as silver, gold, or any suitable reflective metal, and the reflective particles may be functionalized with a different promoter/modifier, e.g., relative to the promoter/modifier of the magnetic particles. In some examples, one or both of the magnetic particles and reflective particles may be nanoparticles.

In some examples, a liquid mirror may include the array of magnets, e.g., positioned on or in a mirror base of the liquid mirror. The array of magnets may be configured to shape the upper surface (e.g., opposite the mirror base surface) of the lower ferrofluid (e.g., the second liquid), such as a focusing shape having an optical quality surface smoothness. However, the magnetic field and/or magnetic force at the lower ferrofluid may have a periodic pattern from the array which may result in variation in fluid height of the lower ferrofluid, e.g., resulting in variations of the upper surface of the lower ferrofluid. For example, the period pattern may be indicative of the size of individual magnets. Inadequate wetting of the lower ferromagnetic layer to the shaped front surface of the mirror base may result in edge effects and may make it difficult to form a liquid mirror with a relatively thin lower ferrofluid.

In examples disclosed herein, a liquid mirror may be configured such that the lower liquid forms a layer having a substantially smooth surface, or interface, with the upper liquid. For example, the lower liquid may be a ferrofluid having a thickness of less than or equal to about 5 millimeters (mm), or less than or equal to about 2 mm, or less than or equal to about 1 mm, or any suitable thickness to reduce or minimize variation in fluid height of the lower ferrofluid.

In some examples, the liquid mirror may include a mirror base having a shaped front surface that is configured to wet the lower ferrofluid across the front surface, e.g., thereby reducing edge effects and enabling the lower ferrofluid to have a thickness that is sufficiently small. For example, the front surface of the mirror base may be configured to wet the lower ferrofluid by enabling the lower ferrofluid to spread out across the front surface of the mirror base and maintain contact with the front surface of the mirror base, effectively displacing any gas (or liquid) present, due to attractive forces between the liquid molecules and the molecules of the front surface of the mirror base, which may be stronger than the cohesive forces within the liquid itself, e.g., to enable the lower ferrofluid to spread out and adhere well to the front surface. The contact angle of the lower ferrofluid on the front surface of the mirror base may indicate how well the lower ferrofluid wets to the front surface. For example, the front surface of the mirror base may be configured such that a contact angle of the lower ferrofluid with the surface is reduced, e.g., less than about 45 degrees, or less than about 10 degrees, or less than about 5 degrees, or less than about 1 degree, or substantially 0 degrees. In some examples, the front surface of the mirror base may comprise an oxide coating, and in some examples the front surface of the mirror base may comprise an anodization or may be anodized. For example, the mirror base may comprise a roughened aluminum, aluminum oxide (e.g., alumina) and/or titanium, and the front surface of the mirror base may comprise anodized aluminum, aluminum oxide, and/or anodized titanium. In some examples, the front surface comprising an oxide, such as an oxide coating, may comprise a plurality of particles configured to increase the surface roughness and/or increase the surface area of the front surface. For example, the front surface may have a plurality of microparticles and/or nanoparticles washcoated onto the surface and then may be annealed. The front surface of the mirror base may be the outer surface of the mirror base facing incident light 120.

In accordance with the devices and methods described herein, a liquid mirror may include a first liquid (e.g., an upper liquid) and a second liquid (e.g., a lower liquid, where lower refers to the liquid in contact with the mirror base) that are immiscible with each other. The second liquid may comprise an ionic ferrofluid. The liquid mirror may also include a plurality of reflective particles configured to self-assemble at an interface between the first and second liquids, and a mirror base configured to house the first and second liquids, e.g., on a surface of the mirror base, and in some examples within the mirror base. The plurality of reflective particles may be configured to self-assemble at the interface between the first and second liquids by interactions and/or forces between the plurality of reflective particles, the first liquid, and the second liquid (e.g., arising from the respective material properties of the reflective particles and the first and second liquids) that drive the reflective particles to the interface, e.g., without external guidance and/or external forces (e.g., other than from the reflective particles and first and second liquids themselves). The mirror base may comprise a surface configured to wet the second liquid across the surface. In some examples, the surface of the mirror base may comprise a hydrophilic and/or oleophilic layer, e.g., that is hydrophilic and/or oleophilic with respect to the second liquid. For example, the surface of the mirror based may comprise an oxide such as an alumina coating, or an anodization of an aluminum, aluminum oxide, and/or titanium surface of the mirror base, the surface having a substantially small contact angle with the second liquid, e.g., less than about 45 degrees, or less than about 10 degrees, or less than about 5 degrees, or less than about 1 degree, or substantially 0 degrees. In some examples, the surface of the mirror base may be rough and/or comprise a microstructure, e.g., having surface features such that the second liquid may fill gaps between the surface features due to gravity, centrifugal force, magnetic force, and/or capillary action. In some examples, the surface of the mirror base may have microstructure such that the surface roughness of the surface of the mirror base is greater than or equal to about 500 micrometers, or greater than or equal to about 100 micrometers, or greater than or equal to about 10 micrometers, or greater than or equal to about 1 micrometer, or greater than or equal to about 0.5 micrometers. In some examples, the microstructure and/or roughness of the surface of the mirror base may increase wetting by the second, lower liquid, e.g., contribute to reducing a contact angle with the second liquid to be substantially small, e.g., less than about 45 degrees, or less than about 10 degrees, or less than about 5 degrees, or less than about 1 degree, or substantially 0 degrees.

In some examples, a liquid mirror may have a shaped reflecting surface, e.g., a focusing shape such as a parabolic or spherical shape. In some examples, the liquid mirror may be tilted and/or slewed, e.g., to aim the mirror at locations to be observed. The second liquid, e.g., a ferrofluid, may be held in place by magnetic force, and the first liquid may be configured to be relatively thin, e.g., less than or equal to 5 mm, or less than or equal to 2 mm, or less than or equal to 1 mm, and may have a substantially uniform thickness.

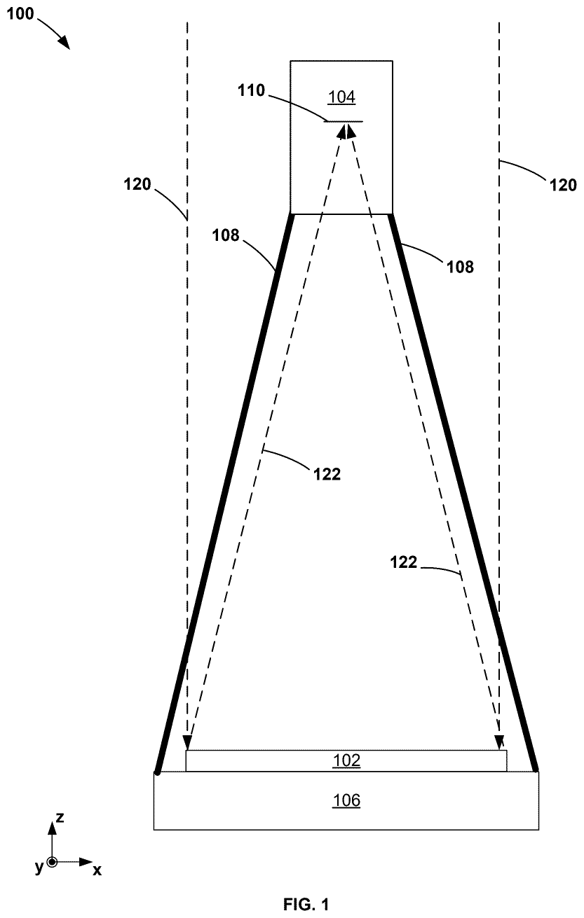

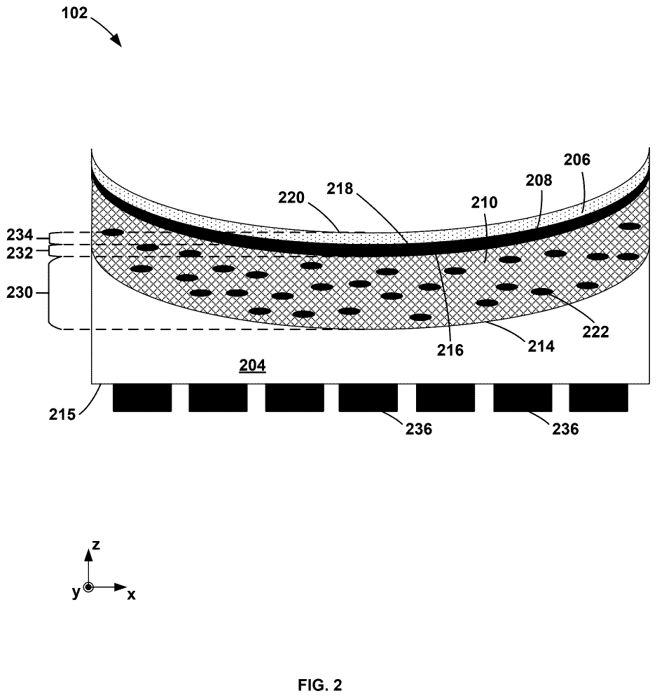

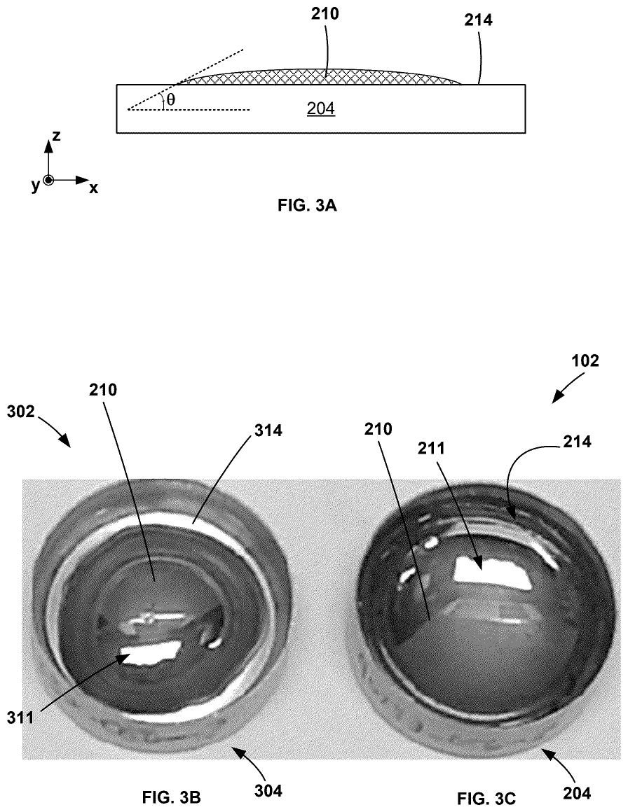

FIG. 1 is a schematic cross-sectional view of an example optical system 100 including a liquid mirror 102. FIG. 2 is a schematic cross-sectional view of example liquid mirror 102, and FIG. 3A is a schematic cross-sectional view of an example contact angle between mirror base surface 214 and second liquid 210 of FIG. 2. FIGS. 1, 2, and 3A are described together below. In the examples shown, optical system 100 may be at least a portion of a liquid mirror telescope (LMT). The LMT may be stationary, e.g., ground based, or attached to, carried by, or included with a vehicle, e.g., a ground vehicle, an aerial vehicle, a water vehicle, a space vehicle, or the like.

Referring to FIG. 1, optical system 100 includes liquid mirror 102, mirror support structure 106, detection module 104, and struts 108 which may be configured to support, position, and hold detection module 104 relative to support structure 106 and liquid mirror 102.

Detection module 104 may include re-imaging optics, e.g., any suitable optical elements including lenses, flat mirrors and/or focusing or non-focusing curved mirrors, diffractive and/or holographic optical elements, windows, spatial and/or spectral filters, or the like. Detection module 104 may also comprise focal plane 110. For example, liquid mirror 102 may be configured to, in conjunction with detection module 104, focus incident light 120 to focal plane 110. Focal plane 110 may be flat or curved. In some examples, focal plane 110 may comprise a focal plane array configured to capture an image of a scene via incident light 120, e.g., a focal plane array of a camera.

Mirror support structure 106 and struts 108 may be configured to provide mechanical support and positioning of liquid mirror 102 and detection module 104, e.g., to maintain the positions and optical axes of liquid mirror 102 and detection module 104 relative to each other.

Liquid mirror 102 is configured to reflect incident light 120 to optical detection module 104, e.g., as reflected light 122. In some examples, liquid mirror 102 may have optical power to converge or diverge incident light 120. For example, liquid mirror 102 may have a reflecting surface having a curved shape, such as a spherical or parabolic two-dimensional shape or one-dimensional (e.g., cylindrical) shape. In some example, liquid mirror 102 may be a primary mirror of an LMT, and detection module 104 may comprise a secondary mirror or lens of the LMT.

Referring to FIG. 2, liquid mirror 102 may comprise mirror base 204, a first liquid 206, interface layer 208, and second liquid 210. Mirror base 204 may comprise a front surface 214 (e.g., a forward-facing surface facing incident light 120) that may have a shape, e.g., flat, curved, spherical, parabolic, or the like. The front surface 214 of mirror base 204 may be at an interface with second liquid 210. Interface layer 208 may be a reflective layer and may comprise a plurality of reflective particles that may be configured to self-assemble at an interface between first liquid 206 and second liquid 210, e.g., forming interface 216 between interface layer 208 and second liquid 210 and interface 218 between interface layer 208 and first liquid 206. For example, first liquid 206 may be immiscible with second liquid 210, and first and second liquids 206, 210 and reflective particles may be configured to allow and/or cause the reflective particles to self-assemble at interface layer 208 between first liquid 206 and second liquid 210, e.g., the polarity, ionicity, density, and other properties of the first and second liquids 206, 210 along with the properties and surface functionalization of the reflective particles may cause the reflective particles to migrate and/or move to the interface layer 208. In some examples, first and second liquids 206, 210 are configured to cause the reflective particles to self-assemble to move to interface layer 208. In some examples, the surface properties of the reflective particles may be adjusted such that, even after shaking the two-liquid mixture, the reflective surface and/or layer of liquid mirror 102 may reappear (e.g., the reflective particles may move and/or migrate to interface layer 208 to re-self-assemble at interface layer 208).

Interface layer 208 may include a plurality of reflective particles. In some examples, interface layer 208 may have a thickness 232 (e.g., nominally in a direction towards mirror base 204 or the z-direction substantially in the middle of liquid mirror 102) that is less than about 10 micrometers, or less than about 1 micrometer, or less than about 500 nanometers, or less than about 200 nanometers, or less than about 150 nanometers, or less than about 100 nanometers, or less than about 50 nm, or a thickness that is about the nominal size of the thickness of the reflective particles (e.g., a “single layer” or “mono layer” of reflective particles). In some examples, interfaces 216 and 218 may be considered to be a single interface (referred to herein as interface 216) between liquids 206, 210, e.g., interface layer 208 may be considered to be a collection of particles or nanoparticles with sufficient surface density at interface 216 to have sufficient reflectivity (e.g., as opposed to a “layer”). In the example shown, first liquid 206 may have a top surface 220 which may be flat, curved (as shown), or have any surface profile, e.g., top surface 220 may not appreciably contribute to reflecting incident light 120 and/or image formation using liquid mirror 102. In some examples, first liquid 206 may have a thickness 234 that is less than about 100 micrometers, or less than about 10 micrometers, or less than about 1 micrometer, or less than about 500 nanometers, or less than about 200 nanometers, or less than about 150 nanometers, or less than about 100 nanometers, or less than about 50 nm, or a thickness that is a “single layer” or a “mono layer.” In some examples, second liquid 210 may have a thickness that is less than about 5 mm, or less than about 2 mm, or less than about 1 mm.

In some examples, reflective particles or nanoparticles may self-assemble at the interface 216 between the two liquids 206, 210, forming the interface layer 208. The first (top) liquid layer 206 (e.g., first relative to incident light 120) may be relatively thin, e.g., having a minimized thickness, to avoid attenuating the incident light 120 reaching the mirror and/or to reduce or minimize distortion due to a varying thickness and optical path length through first liquid 206. The second (base) liquid layer 210 may be configured to provide an optical-quality surface, e.g., which may be at interface 216. The mirror base 204 need not have wavefront accuracy, e.g., it may only be accurate to 100's of microns, while the liquid interface 216 follows a shape dictated by a force such as a magnetic (e.g., for the second liquid 210 as a ferrofluid), an acceleration and spin of liquid mirror 102, or any suitable force. In some examples, surface 214 of the mirror base 204 is configured to wet the second liquid 210 such that the plurality of reflective particles self-assemble to form a reflective layer, e.g., at interface layer 208 and/or liquid interface 216, with the focusing shape and having a wavefront error of less than or equal to λ/2, e.g., a paraboloidal shape.

In the example shown, second liquid 210 is a ferrofluid including a plurality of magnetic particles 222. Second liquid 210 may be a polar ionic liquid, and magnetic particles 222 may include a polar coating. In some examples, magnetic particles 222 may be nanoparticles having a modified surface configured to preferentially be wetted by the polar, ionic liquid 210. In some examples, magnetic particles 222 may be comprised of maghemite, magnetite, or any suitable magnetic material. In some examples, mirror base 204 may include an array of permanent and/or tunable magnets 236 configured to cause second liquid 210 to form a focusing shape at an outer second liquid surface of the second liquid 210. e.g., at the interface 216 between the first liquid 206 and second liquid 210.

In some examples, second liquid 210 comprises a polar, ionic ferrofluid and is immiscible with first liquid 206, and first and second liquids 206, 210 are configured to allow reflective particles to self-assemble in the right order in gravity and under magnetic influence (e.g., a magnetic field) to force the reflective particles to interface layer 208. First liquid 206 may have a substantially different polarity from second liquid 210 to facilitate self-assembly of reflective particles. Second liquid 210 may comprise any or all of 1-ethyl-3-methylimidazolium ethylsulfate (EMIM EtSO4) (which may have a surface tension of about 48 millinewtons per meter (mN/m)), 1-ethyl-3-methylimidazolium bis(trifluoromethylsulfonyl)amide, 1-ethyl-3-methylimidazolium methanesulfonate (mesylate), butyltrimethylammonium bis(trifluoromethylsulfonyl)imide, 1-hexyl-3-methylimidazolium chloride, and/or the like. Second liquid 210 may be configured to be compatible with ferrofluid ligands, e.g., of magnetic particles 222, to support magnetic particles 222, and first liquid 206 may be configured to be incompatible with, repel, or be less compatible with the ferrofluid ligands of magnetic particles 222, e.g., to prevent magnetic particles 222 from migrating to first liquid 206 and/or interface layer 208. The second liquid 210 may also be configured to repel reflective particles, e.g., to facilitate self-assembly of reflective particles and prevent reflective particles from falling into second liquid 210. First liquid 206 may be configured to interact well with reflective particles to spread thin and cover reflective particles.

FIG. 3A is a schematic cross-sectional view of an example contact angle between mirror base surface 214 and second liquid 210 of FIG. 2. In the example shown, a drop of second liquid 210 is on mirror base surface 214 and forms a bead or droplet having a contact angle θ with surface 214 based on the surface tension of the drop of second liquid 210 and the surface energy of surface 214. In the example shown, the contact angle θ is measured at the edge of the drop of second liquid 210. In some examples, the contact angle θ may be less than about 45 degrees, or less than about 10 degrees, or less than about 5 degrees, or less than about 1 degree, or substantially 0 degrees, e.g., liquid 210 may spread across surface 214 to a maximum extent and a minimum liquid thickness. In some examples, a contact angle θ of less than about 90 degrees may be hydrophilic (e.g., for second liquid 210 comprising water), a contact angle θ of less than about 5 degrees may be superhydrophilic, a contact angle θ of less than about 90 degrees may be oleophilic (e.g., for second liquid 210 comprising an oil), and a contact angle θ of near zero degrees, e.g., less than about 3 degrees, may be superoleophilic. In some examples, surface 214 may be configured to be any of hydrophilic, superhydrophilic, oleophilic, or superoleophilic with respect to second liquid 210.

The relationship between liquid thickness h, surface tension y of the liquid, and the contact angle θ between the liquid and a surface that the liquid is in contact may be described by Equation 1, where g is acceleration due to gravity (or another force, such as a centrifugal force), a_{M} is acceleration due to a magnetic force (e.g., for second liquid 210 as a ferrofluid), and p is density of the fluid.

$$h = \sqrt{\frac{2 γ ( 1 - cos θ )}{( g + {a}_{M} ) ρ}} \qquad ( 1 )$$

As shown in Equation 1, decreasing the surface tension y or decreasing the contact angle θ reduces the thickness h of the liquid layer. However, when a magnetic force is not present, a low contact angle θ may be preferred to achieve good wetting and a reduced and/or substantially small liquid layer thickness h.

In some examples, the surface tension y of the second liquid 210 may not be easily changed, however, the contact angle θ of the second liquid 210 with surface 214 of mirror base 204 may be affected by properties of both second liquid 210 and surface 214, e.g., the surface energy of surface 214. For example, in order to reduce the thickness h of second liquid 210 disposed on surface 214, the contact angle θ may be reduced, e.g., via a coating or treatment of surface 214. FIG. 3B is an image of an example liquid mirror 302 housed in (or on) a mirror base 304 including a surface 314 of a mirror base 304 having a relatively high contact angle θ with second liquid 210 (e.g., an untreated surface 314). FIG. 3C is an image of example liquid mirror 102 housed in (or on) mirror base 204 including surface 214 of mirror base 204 having a relatively low contact angle θ with second liquid 210 (e.g., a treated surface). In the example shown in FIG. 3C, the second liquid 210 has spread evenly across surface 214 (e.g., having a low contact angle θ) to fully cover surface 214. In some examples, second liquid 210 in example FIG. 3C may fully cover surface 214 and begin to climb the vertical walls of mirror base 204 extending from surface 214 (the edge effects of which on mirror optical performance may be tolerable and/or negligible). In the example shown in FIG. 3B, the second liquid 210 has beaded up (e.g., having a high contact angle θ), e.g., as a spheroid droplet resting on the surface 314, as indicated by portions of surface 314 not covered by second liquid 210. In FIG. 3B, second liquid 210 is drawn up into a domed shape to minimize the contact between second liquid 210 and surface 314, thereby disadvantageously changing the surface shape of the surface of second liquid 210 that would form at interface 216 from concave to convex, as indicated by the non-inverted reflection 311 of the similar scene that is inverted reflection 211 shown in FIG. 3C. In some examples, the first liquid of liquid mirror 302 may be philic with surface 314, and may exacerbate and/or increase the contact angle θ, e.g., and the beading up, of second liquid 210 with surface 314. In the examples shown, the second liquid 210 on surface 314 has a larger thickness h (Equation 1) than the second liquid 210 on surface 214.

In some examples, the surface 214 of mirror base 204 may be configured to have a reduced contact angle θ with second liquid 210, and thereby reduce the thickness h of second liquid 210. For example, surface 214 may comprise an oxide coating, or a surface treatment such as anodization. In some examples, the coating and/or surface treatment may comprise a microstructure, e.g., a surface 214 having a micrometer-scale surface roughness. In some examples, the coating and/or surface treatment may be configured to reduce the contact angle θ of second liquid 210 on surface 214 to almost zero, allowing complete wetting and a small liquid thickness h.

In some examples, surface 214 may be configured to repel (e.g., to not wet) first liquid 206. For example, surface 214 may be configured to be hydrophobic, superhydrophobic, oleophobic, or superoleophobic with first liquid 206. Surface 214 may be configured to repel first liquid 206, e.g., such that first liquid 206 stabilizes as the top liquid and does not get stuck within second liquid 210. In some examples, a contact angle θ of greater than or equal to about 90 degrees may be hydrophobic (e.g., for first liquid 206 comprising water), a contact angle θ of greater than about 105 degrees may be oleophobic (e.g., for first liquid 206 comprising an oil), a contact angle θ of greater than about 150 degrees may be superhydrophobic and/or superoleophobic. In some examples, surface 214 may be configured to be any of hydrophobic, superhydrophobic, oleophobic, or superoleophobic with respect to first liquid 206.

In the example shown in FIG. 2, mirror base 204 comprises a curved mirror base surface 214 that may generally define a light focusing shape, and a rear surface 215 that is substantially flat. In other examples, mirror base 204 may have curved rear surface, e.g., that may follow the curvature of surface 214. Mirror base 204 may by substantially rigid have a thickness of about 0.1 mm to 10 mm, or about 0.5 mm to 5 mm, or about 1 mm to 3 mm. In some examples, surface 214 may have a curvature and diameter such that the center of surface 214 is about 5 mm to 25 mm lower than the edges, or about 10 mm to 20 mm lower than the edges, or about 15.6 mm lower than the edge. The center depth of surface 214 may be determined based on the diameter of liquid mirror 102 and, for example, the design of the optical system in which liquid mirror 102 is used, e.g., optical system 100. Mirror base 204 may comprise aluminum, aluminum oxide, and/or titanium. For example, aluminum, aluminum oxide, and/or titanium have magnetic properties conducive to forming liquid mirror 200 with magnets 236 and second liquid 210 as a lower ferrofluid. For example, the magnetic permeability of aluminum, aluminum oxide, and/or titanium may be less than about 5*10⁻⁶ Henries per meter (H/m), as compared to stainless steel which may have a magnetic permeability of greater than 1*10⁻³ H/m. In some examples, mirror base 204 may be coated with alumina, silica, mixtures of alumina and silica and/or or other metal oxides. For example, the oxide coating may be wet coated onto mirror base 204, dried, and calcinated to increase the adhesion between oxide coating and mirror base 204. In some examples, the coating may comprise a gamma alumina coating or an alpha alumina coating (e.g., referring to as phase of the oxide). In other examples, an electric current may be applied to the metallic surface for mirror base 204 while the surface is immersed in an anodization solution, such as an acidic solution, to oxidize and roughen the surface of mirror base 204 to form surface 214.

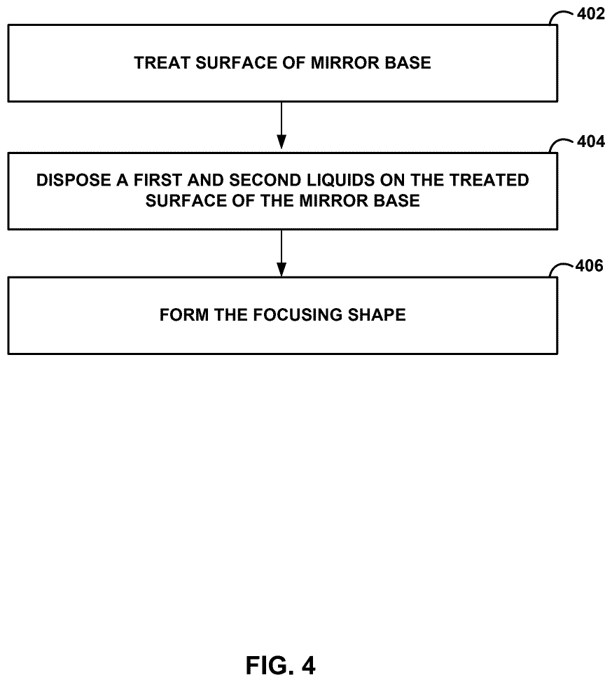

FIG. 4 is a flow diagram illustrating an example technique of forming a liquid mirror. FIG. 4 is described with reference to optical system 100 of FIG. 1, liquid mirror 102 of FIGS. 1, 2, 3A, and 3C. However, the techniques of FIG. 4 may be utilized to make different liquid mirrors and/or additional optical systems.

An operator (or system) may treat surface 214 of mirror base 204 (402). For example, the operator may coat surface 214 with an oxide, such as an aluminum oxide, and/or the operator may anodize surface 214 and/or the coating on surface 214, such that second liquid 210 wets well across surface 214. In some examples, the operator may treat surface 214 by forming a microstructure on surface 214, e.g., a microstructure comprising a surface roughness (which may be an average surface roughness or Ra of the surface) of greater than or equal to about 500 micrometers, or greater than or equal to about 100 micrometers, or greater than or equal to about 10 micrometers, or greater than or equal to about 1 micrometer, or greater than or equal to about 0.5 micrometers.

In some examples, e.g., for treating surface 214 by coating surface 214 with an oxide coating, the operator may washcoat surface 214 and calcinate the coating, e.g., via heating. In some examples, the operator may then convert the alumina from a gamma phase to an alpha phase, e.g., via further heating.

The operator (or system) may dispose first and second liquids 206, 210 onto treated surface 214 of mirror base 204 (404). In some examples, the operator may directly dispose first and second liquids 206, 210 onto treated surface 214, e.g., via liquid transport device such as a tube, a syringe, or any suitable device. In other examples, the system may dispose first and second liquids 206, 210 onto treated surface 214. For example, support structure 106 or mirror base 204 may release first and second liquids 206, 210 from one or more reservoirs within support structure 106 and/or mirror base 204 to flow onto treated surface 214 of mirror base 204, or first and second liquids 206, 210 may be disposed onto surface 214 by an external apparatus.

In some examples, the first and second liquids 206, 210 may be thoroughly mixed, e.g., before being disposed across the surface 214, while being disposed across the surface 214, or after being disposed across the surface 214. For example, the first and second liquids 206, 210 may be stored in the same reservoir and mixed, e.g., via induced shear. First and second liquids 206, 210 may be mixed so as to dispose reflectively particles throughout the mixture for subsequent uniform self-assembly of interface layer 208. In other examples, the first and second liquids 206, 210 may be stored in the same or different reservoirs and forced through a mixer that applies shear and disperses the first and second liquids 206, 210, including any particles or nanoparticles, such as reflective particles 228 and/or magnetic particles 222, contained within either the first and/or the second liquids 206, 210, within each other.

The operator (or system) may form the focusing shape of liquid mirror, e.g., by applying a force to the first and second liquids 206, 210 (406). For example, a vehicle including optical system 100 may cause liquid mirror 102 to accelerate and spin, causing first and second liquids 206, 210 to form an optical focusing shape, such as a paraboloidal shape. In some examples, second liquid 210 may be a ferrofluid. Liquid mirror 102 may include one or more permanent magnets 236 and/or electromagnets 236 configured to cause a magnetic field to be applied to second liquid 210. The magnetic field may then interact with ferrofluidic second liquid 210 and/or one or more magnetic particles 222 of second liquid 210 to cause a magnetic force to be applied to second liquid 210 such that reflective particles 228 self-assemble into a focusing shape at interface layer 208, such as a paraboloidal shape.

Select examples of the present disclosure include, but are not limited to, the following examples.

Example 1: A liquid mirror includes a first liquid and a second liquid, wherein the first liquid and the second liquid are immiscible with each other, wherein the second liquid comprises an ionic ferrofluid; a plurality of reflective particles configured to self-assemble at an interface between the first liquid and the second liquid; and a mirror base configured to house the first and second liquids, the mirror base comprising a surface configured to wet the second liquid across the surface.

Example 2: The liquid mirror of example 1, wherein the surface is configured to repel the first liquid.

Example 3: The liquid mirror of example 1 or example 2, wherein the surface comprises a hydrophilic layer.

Example 4: The liquid mirror of any one of examples 1 through 3, wherein the surface comprises an oxide.

Example 5: The liquid mirror of any one of examples 1 through 4, wherein the mirror base comprises at least one of aluminum, aluminum oxide, titanium, or titanium oxide.

Example 6: The liquid mirror of example 5, wherein the surface comprises at least one of an alumina coating or an anodization of the surface of the aluminum, the aluminum oxide, the titanium, or the titanium oxide of the mirror base.

Example 7: The liquid mirror of any one of examples 1 through 6, wherein the surface comprises a microstructure.

Example 8: The liquid mirror of example 7, wherein the microstructure comprises a surface roughness of greater than or equal to 10 micrometers.

Example 9: The liquid mirror of any one of examples 1 through 8, wherein a thickness of the second liquid is less than or equal to 5 millimeters.

Example 10: The liquid mirror of any one of examples 1 through 9, wherein the second liquid comprises a ferrofluid, wherein the liquid mirror further comprises an array of magnets configured to cause the second liquid to form a focusing shape at an outer second liquid surface of the second liquid at the interface between the first and second liquids, wherein the surface of the mirror base is configured to wet the second liquid such that the plurality of reflective particles at the interface self-assemble to form a reflective layer with the focusing shape and having a wavefront error of less than or equal to λ/2.

Example 11: A telescope includes a focal plane configured to capture an image of a scene; a liquid mirror includes a first liquid and a second liquid, wherein the first liquid and the second liquid are immiscible with each other, wherein the second liquid comprises an ionic ferrofluid; a plurality of reflective particles configured to self-assemble at an interface between the first and second liquids; and a mirror base configured to house the first liquid and the second liquid, the mirror base comprising a surface configured to wet the second liquid across the surface; and a support structure configured to position the liquid mirror to image light to the focal plane, wherein the support structure is configured to tilt and slew the liquid mirror and focal plane together.

Example 12: The telescope of example 11, wherein the surface is configured to repel the first liquid.

Example 13: The telescope of example 11 or example 12, wherein the surface comprises a hydrophilic layer.

Example 14: The telescope of any one of examples 11 through 13, wherein the surface comprises an oxide.

Example 15: The telescope of any one of examples 11 through 14, wherein the mirror base comprises at least one of aluminum, aluminum oxide, titanium, or titanium oxide.

Example 16: The liquid mirror of example 15, wherein the surface comprises at least one of an alumina coating or an anodization of the surface of the aluminum, the aluminum oxide, the titanium, or the titanium oxide of the mirror base.

Example 17: The telescope of any one of examples 11 through 16, wherein the surface comprises a microstructure.

Example 18: The telescope of example 17, wherein the microstructure comprises a surface roughness of greater than or equal to 10 micrometers, wherein a thickness of the second liquid is less than or equal to 5 millimeters.

Example 19: The telescope of any one of examples 11 through 18, wherein the second liquid comprises a ferrofluid, wherein the liquid mirror further comprises an array of magnets configured to cause the second liquid to form a focusing shape at an outer second liquid surface of the second liquid at the interface between the first and second liquids, wherein the surface of the mirror base is configured to wet the second liquid such that the plurality of reflective particles at the interface self-assemble to form a reflective layer with the focusing shape and having a wavefront error of less than or equal to λ/2.

Example 20: A method of forming a liquid mirror, the method including: treating a surface of a mirror base with at least one of an oxide or an anodization; disposing a first liquid, a second liquid, and a plurality of reflective particles onto the surface, wherein the first liquid and the second liquid are immiscible with each other, wherein the second liquid comprises an ionic ferrofluid, wherein the plurality of reflective particles are configured to self-assemble at an interface between the first and second liquids; and forming a focusing shape of a liquid mirror by applying a magnetic force to the second liquid such that the reflective particles self-assemble into the focusing shape at the interface.

Various examples have been described. These and other examples are within the scope of the following claims.

What is claimed is:

1. A liquid mirror comprising:
a first liquid and a second liquid, wherein the first liquid and the second liquid are immiscible with each other, wherein the second liquid comprises an ionic ferrofluid;
a plurality of reflective particles configured to self-assemble at an interface between the first liquid and the second liquid; and
a mirror base configured to house the first liquid and the second liquid, the mirror base comprising a surface configured to wet the second liquid across the surface.

2. The liquid mirror of claim 1, wherein the surface is configured to repel the first liquid.

3. The liquid mirror of claim 1, wherein the surface comprises a hydrophilic layer.

4. The liquid mirror of claim 1, wherein the surface comprises an oxide.

5. The liquid mirror of claim 1, wherein the mirror base comprises at least one of aluminum, aluminum oxide, titanium, or titanium oxide.

6. The liquid mirror of claim 5, wherein the surface comprises at least one of an alumina coating or an anodization of the surface of the aluminum, the aluminum oxide, the titanium, or the titanium oxide of the mirror base.

7. The liquid mirror of claim 1, wherein the surface comprises a microstructure.

8. The liquid mirror of claim 7, wherein the microstructure comprises a surface roughness of greater than or equal to 10 micrometers.

9. The liquid mirror of claim 1, wherein a thickness of the second liquid is less than or equal to 5 millimeters.

10. The liquid mirror of claim 1,
wherein the liquid mirror further comprises an array of magnets configured to cause the second liquid to form a focusing shape at an outer second liquid surface of the second liquid at the interface between the first liquid and the second liquid,
wherein the surface of the mirror base is configured to wet the second liquid such that the plurality of reflective particles at the interface self-assemble to form a reflective layer with the focusing shape and having a wavefront error of less than or equal to λ/2.

11. A telescope comprising:
a focal plane configured to capture an image of a scene;
a liquid mirror comprising:
a first liquid and a second liquid, wherein the first liquid and the second liquid are immiscible with each other, wherein the second liquid comprises an ionic ferrofluid;
a plurality of reflective particles configured to self-assemble at an interface between the first liquid and the second liquid; and
a mirror base configured to house the first liquid and the second liquid, the mirror base comprising a surface configured to wet the second liquid across the surface; and
a support structure configured to position the liquid mirror to image light to the focal plane, wherein the support structure is configured to tilt and slew the liquid mirror and focal plane together.

12. The telescope of claim 11, wherein the surface is configured to repel the first liquid.

13. The telescope of claim 11, wherein the surface comprises a hydrophilic layer.

14. The telescope of claim 11, wherein the surface comprises an oxide.

15. The telescope of claim 11, wherein the mirror base comprises at least one of aluminum, aluminum oxide, titanium, or titanium oxide.

16. The telescope of claim 15, wherein the surface comprises at least one of an alumina coating or an anodization of the surface of the aluminum, the aluminum oxide, the titanium, or the titanium oxide of the mirror base.

17. The telescope of claim 11, wherein the surface comprises a microstructure.

18. The telescope of claim 17, wherein the microstructure comprises a surface roughness of greater than or equal to 10 micrometers, wherein a thickness of the second liquid is less than or equal to 5 millimeters.

19. The telescope of claim 11,
wherein the liquid mirror further comprises an array of magnets configured to cause the second liquid to form a focusing shape at an outer second liquid surface of the second liquid at the interface between the first and second liquids,
wherein the surface of the mirror base is configured to wet the second liquid such that the plurality of reflective particles at the interface self-assemble to form a reflective layer with the focusing shape and having a wavefront error of less than or equal to λ/2.

20. A method of forming a liquid mirror, the method comprising:
treating a surface of a mirror base with at least one of an oxide or an anodization;
disposing a first liquid, a second liquid, and a plurality of reflective particles onto the surface, wherein the first liquid and the second liquid are immiscible with each other, wherein the second liquid comprises an ionic ferrofluid, wherein the plurality of reflective particles are configured to self-assemble at an interface between the first and second liquids; and
forming a focusing shape of a liquid mirror by applying a magnetic force to the second liquid such that the reflective particles self-assemble into the focusing shape at the interface.
